(19) United States
(12) Patent Application Publication
(10) Pub. No.: US 2010/0259419 A1
(43) Pub. Date: Oct. 14, 2010

(54) STOPLIGHT TIMER

(76) Inventors: Russell Renner, Lovell, WY (US); Toni Renner, Lovell, WY (US)

Correspondence Address: James Ray & Associates, 2640 Pitcairn Road, Monroeville, PA, 15146, US

(21) Appl. No.: 12/758,351

(22) Filed: Apr. 12, 2010

Related U.S. Application Data
(60) Provisional application No. 61/168,956, filed on Apr. 14, 2009.

(51) Int. Cl. G08G 1/096

(52) U.S. Cl. 340/929

(57) ABSTRACT

In combination with a standard traffic control signal having green, yellow and red lights disposed therein and lit in sequence for control of traffic, the improvement comprises an apparatus for providing a warning to drivers as to when a green light on a standard traffic signal will be changing to yellow. The apparatus comprises a countdown timer member disposed one of adjacent to and within such green light of such traffic signal for counting down a predetermined number of seconds before such green light turns to yellow and a countdown display monitor disposed one of in and adjacent to such timer member for displaying final seconds before such green light turns to yellow.

### CROSS REFERENCE TO RELATED APPLICATIONS

This application is closely related to and claims benefit from U.S. Provisional Application Ser. No. 61/168,956 filed Apr. 14, 2009.

### STATEMENT REGARDING FEDERALLY SPONSORED RESEARCH OR DEVELOPMENT

N/A

### FIELD OF THE INVENTION

The present invention relates, in general, to a stoplight and, more particularly, the present invention relates to a timer in which a warning that the green light is ready to change to yellow is shown thereby allowing drivers to clearly see how much time is left before the green light turns yellow thereby assisting drivers in staying calm and safe when approaching intersections.

### BACKGROUND

There are many people who run traffic lights because, to them, the lights change very quickly, not leaving enough time to stop for a yellow light without creating an accident. Individuals may need a better warning of when a traffic light is going to become yellow and eventually lead to a red light, so they can make a decision without being panicked. Having a timer that allows drivers to clearly see how much time is left before a green light turns yellow may assist individuals in staying safe and calm when approaching intersections.

### BRIEF SUMMARY OF THE INVENTION

In a first aspect the present invention provides an apparatus for providing a warning as to when a green light on a traffic signal will be changing to yellow, the apparatus comprises a countdown timer member disposed adjacent such traffic signal for counting final seconds before such green light turns to yellow. A countdown display monitor is disposed one of adjacent to and in the countdown timer member for displaying the final seconds before such green light turns to yellow and a means disposed in the apparatus and engageable with such traffic signal circuitry and with such countdown timer member and such countdown display monitor for providing power to the countdown timer member and the countdown display monitor.

In a second aspect the present invention is disposed in combination with a standard traffic control signal having green, yellow and red lights disposed therein and lit in sequence for control of traffic, the improvement comprising an apparatus for providing a warning to drivers as to when a green light on a standard traffic signal will be changing to yellow. The apparatus comprises a countdown timer member disposed one of adjacent to and within such green light of such traffic signal for counting down a predetermined number of seconds before such green light turns to yellow and a countdown display monitor disposed one of in and adjacent to such timer member for displaying final seconds before such green light turns to yellow.

### OBJECTS OF THE INVENTION

It is, therefore, one of the primary objects of the present invention to provide a timer to count the last seconds before a green light turns yellow.

Another object of the present invention is to provide a display monitor that will show the seconds left before a green light turns yellow.

Still another object of the present invention is to provide a display monitor that will show the seconds left before a green light turns yellow where the monitor faces in all directions.

Yet another object of the present invention is to provide a display monitor that is mounted in the green light.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE SEVERAL VIEWS OF THE DRAWINGS

FIG. 1 is a partial perspective view of the apparatus disposed on a traffic signal showing a truck at an intersection.

FIG. 2 is a partial perspective view of the apparatus showing the display monitor connected to the side of a traffic signal.

FIG. 3 is a partial perspective view of a traffic signal showing the display monitor disposed with the green light of the traffic signal.

FIG. 4 is a perspective view of a traffic signal with the timer and display monitor disposed on the bottom of the traffic signal.

FIG. 5 is a perspective view of a traffic signal with the timer and display monitor disposed on the bottom of the traffic signal with the display monitor facing in all directions.

FIG. 6 is a block diagram showing the present invention in conjunction with a standard traffic light.

### DETAILED DESCRIPTION OF INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing a warning as to when a green light on a traffic signal will be changing to yellow, the apparatus comprises a countdown timer member 6 disposed adjacent such traffic signal 4 for counting final seconds before such green light turns to yellow. A countdown display monitor 2 is disposed one of adjacent to and in the countdown timer member 6 for displaying the final seconds before such green light turns to yellow; and a means, generally designated 20, disposed in the apparatus 10 for providing power to the countdown timer member 6 and the countdown display monitor 2.

In a second aspect the present invention, generally designated 10, is disposed in combination with a standard traffic control signal 4 having green 12 yellow 14 and red 16 lights disposed therein and lit in sequence for control of traffic, the improvement comprising an apparatus 10 for providing a warning to drivers as to when a green light 12 on a standard traffic signal 4 will be changing to yellow 14. The apparatus comprises a countdown timer member 6 disposed one of adjacent to and within such green light 12 of such traffic signal 4 for counting down a predetermined number of seconds before such green light 12 turns to yellow 14 and a countdown display monitor 2 disposed one of in and adjacent to such timer member 6 for displaying final seconds before such green light 12 turns to yellow 14.

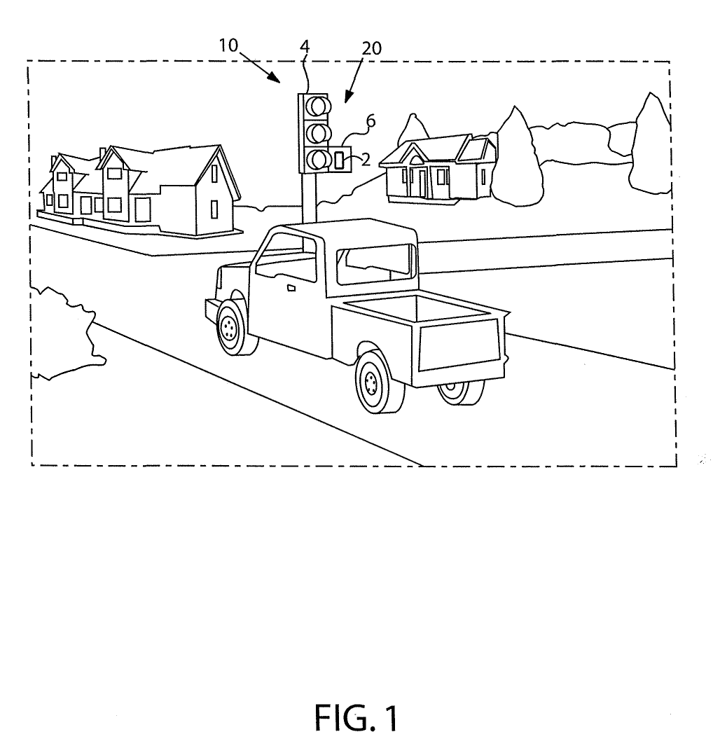

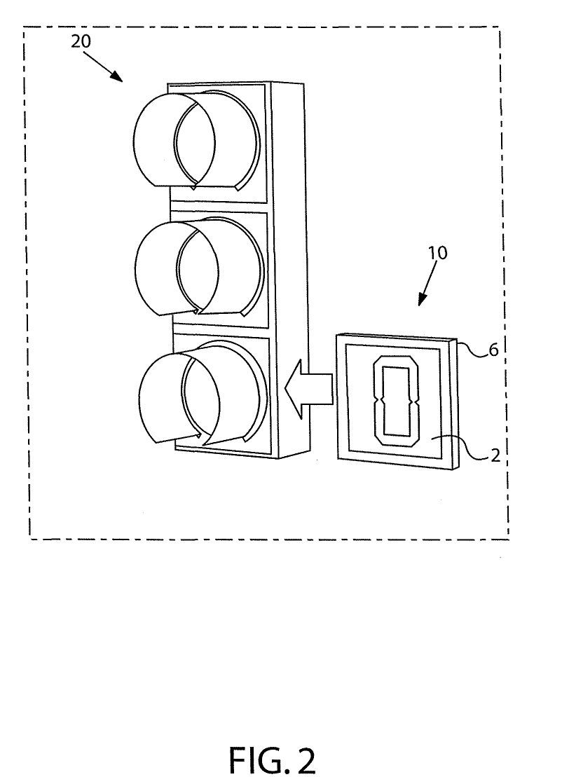

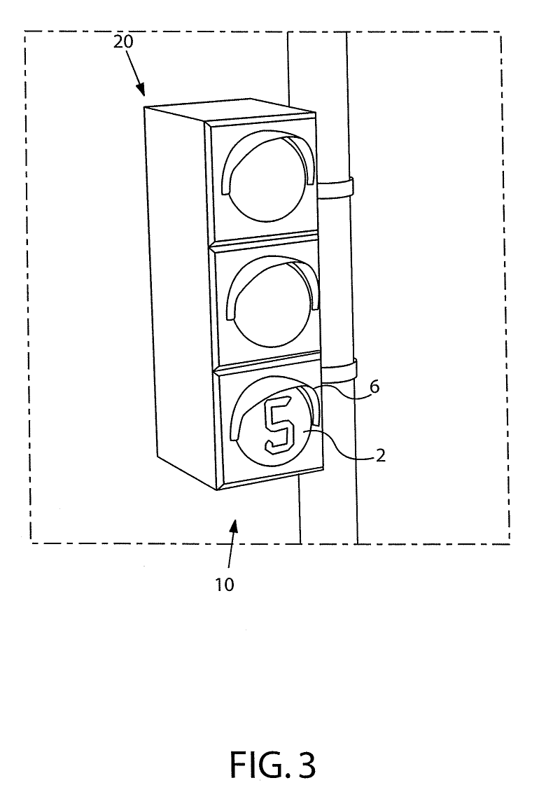

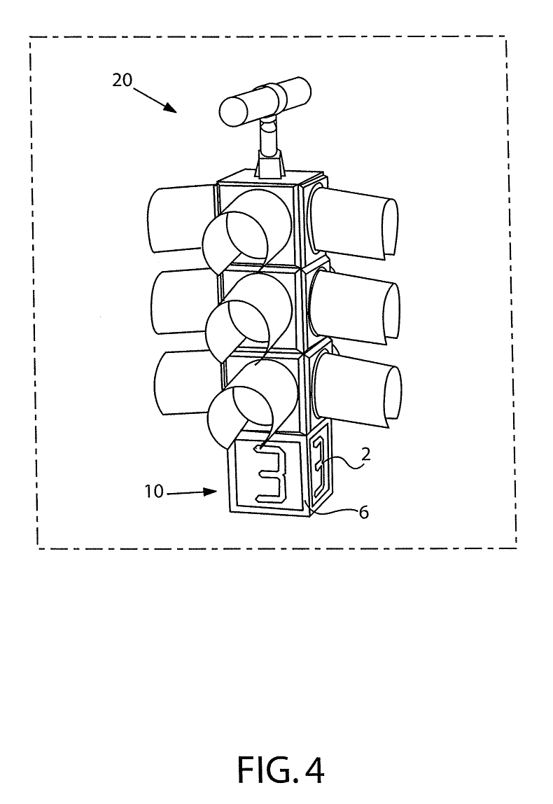

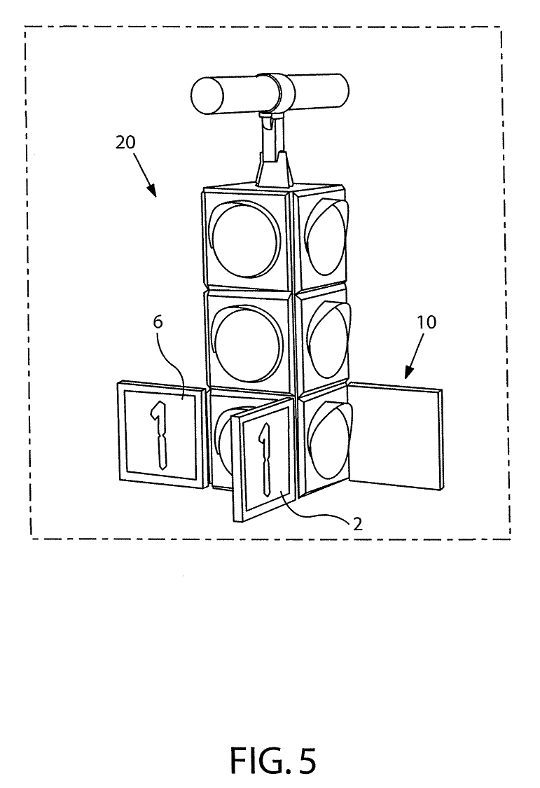

Thus, the present invention provides a means of alerting drivers as to how many seconds remain in the green light before the traffic signal switches from the green light to a yellow light. As can be seen in the drawings FIGS. 1-5 such countdown timer member 6 and such countdown display monitor 2 can be disposed adjacent and on the side of the existing green light in one embodiment. The countdown timer member 6 and the countdown display monitor 2 can be disposed within the existing green light in an alternate embodiment or they can be disposed below the green light in yet another embodiment. In still another embodiment the countdown display monitor 2 can be disposed so as to point in all four directions. The countdown display monitor 2 counts down the last five seconds before such green light goes off and the yellow light comes on. Although it is presently preferred that such countdown include the last five seconds it is within the scope of the invention that such number of seconds could be a different number.

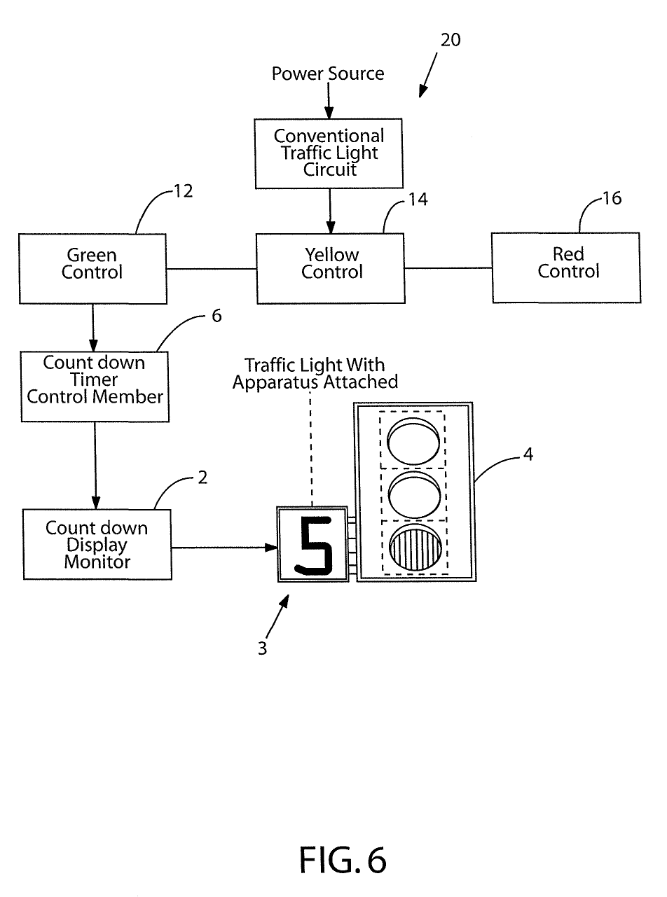

FIG. 6 shows a block diagram of the use of the apparatus 10 of the present invention. A power source is connected to a conventional traffic signal light circuit, generally designated 20. The circuit is connected to a green light control 12, a yellow light control 14 and a red light control 16. The green light control 12 is further connected to countdown timer control member 6 which is connected to countdown display monitor 2. The countdown display monitor 2 controls the illumination of the numerical sequence of the modular system 3 of traffic lights 4. Thus, the components of the signal change indicator system becomes part of the conventional traffic light circuit 20. The yellow and red control units 14, 26 are bypassed and a connection is made only between the green control unit 12 and the countdown timer control 6. The countdown timer control 6 initiates or interrupts and guides the operation of the countdown display monitor 2. The signal change indicator system is attached and secured to the optical lens housing of a conventional traffic light assembly 4 visually in-line with the green optical lens.

The Stoplight Timer is an apparatus that can be installed into standard traffic lights to provide drivers with a countdown, showing when a light will change from green to yellow so that the driver may take the proper precautions. This unique product can assist users in staying safe by giving them ample warning of when a green light is going to change to yellow so that they may slow down in enough time to stop at the red light. This item is ideal for use at any intersection to prevent accidents that may occur because drivers may panic to stop at the last second before a light turns red. This apparatus is easy to install and can also be beneficial in warning buses or trucks carrying a large load that a red light may be near so that they have ample time to stop and prevent the load from shifting or in the case of trucks and buses can stop without causing passengers to slide when the bus stops quickly.

Thus, the Stoplight Timer offers a simple and safe way to be notified of how many seconds are left before the traffic light turns yellow. This product may have several variations in where the monitor can be installed on the traffic light. One version allows the monitor showing the countdown to be installed on the side of a green light that is attached to a pole on its backside or a single side. Another design may allow for installation onto the sides of the traffic light with four lights built into one unit. Each facing a different direction of the intersection. One version may allow the timer to be affixed to the bottom of the traffic light. A final design may have the countdown shown directly within the green light's bulb. The timer may count down from five to zero, giving motorists a five second warning before the light changes to yellow. The unit may be installed into the wiring of the existing light and when five seconds remain on the existing timer, it may send power to the timer clock that would countdown until it reaches zero. The yellow light would then come on and the timer would no longer be lit. Depending on the speed of the traffic or poor weather conditions this product may have the ability to be changed to allow for nine seconds of warning time instead of just five. Multiple LED bulbs in various number formations, like those found in digital clocks, may light the display monitor. This apparatus may be produced as an accessory for existing stop lights or as a built in option on future models.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for providing a warning to drivers as to when a green light on a standard traffic signal light will be changing to yellow, said apparatus comprising:
(a) a countdown timer member disposed one of within and adjacent to such traffic signal light for counting a predetermined number of seconds before such green light turns to yellow;
(b) a countdown display monitor disposed one of in and adjacent said countdown timer member for displaying final seconds before such green light turns to yellow; and
(c) a means engageable with said timer member and said display monitor and with a power source for such standard traffic signal for providing power to said countdown timer member and said countdown display monitor.

2. The apparatus, according to claim 1, wherein said timer counts final five seconds before such green light turns to yellow.

3. The apparatus, according to claim 1, wherein said means includes installation into existing wiring of such standard traffic light.

4. The apparatus, according to claim 1, wherein said countdown display monitor is mounted below such green light of such standard traffic signal.

5. The apparatus, according to claim 1, wherein said countdown display monitor is mounted on a side of such green light of such standard traffic signal.

6. The apparatus, according to claim 1, wherein said countdown display monitor is mounted adjacent such green light of such traffic signal so to have a display facing in all four directions.

7. In combination with a standard traffic signal having green yellow and red lights disposed therein and lit in sequence for control of traffic, the improvement comprising an apparatus for providing a warning to drivers as to when a green light on a standard traffic signal will be changing to yellow, said apparatus comprising:
(a) a countdown timer member disposed one of adjacent to and within said green light of said traffic signal for counting down a predetermined number of seconds before such green light turns to yellow; and
(b) a display monitor disposed one of in and adjacent to said timer member for displaying final seconds before such green light turns to yellow.

8. The combination, according to claim 7, wherein said timer counts final five seconds before said green light turns to yellow.

9. The combination, according to claim 7, wherein said display monitor displays final five seconds before said green light turns to yellow.

10. The combination, according to claim 7, wherein said countdown display monitor is mounted below said green light of said standard traffic signal.

11. The combination, according to claim 7, wherein said countdown display monitor is mounted on a side of said green light of said standard traffic signal.

12. The combination, according to claim 7, wherein said countdown display monitor is mounted adjacent said green light of said traffic signal so to have a display facing in all four directions.
